(19) United States
(12) Patent Application Publication
(10) Pub. No.: US 2026/0030902 A1
(43) Pub. Date: Jan. 29, 2026

(54) RECOGNISING A ROADWAY COATING ON A ROADWAY

(71) Applicant: Continental Autonomous Mobility Germany GmbH, Ingolstadt (DE)

(72) Inventors: Bernd Hartmann, Bad Homburg (DE); Stefan Hegemann, Wangen im Allgäu (DE); Sighard Schräbler, Karben (DE); Florian Geis, Geisenheim (DE)

(73) Assignee: Continental Autonomous Mobility Germany GmbH, Ingolstadt (DE)

(21) Appl. No.: 19/124,178

(22) PCT Filed: Sep. 26, 2023
(86) PCT No.: PCT/DE2023/200203

§ 371 Date: Apr. 24, 2025

(30) Foreign Application Priority Data
Oct. 24, 2022 (DE) 10 2022 211 241.5

(51) Int. Cl. G06V 20/56; G06V 10/764; G06V 10/82; H04N 23/73

(52) U.S. Cl. CPC G06V 20/588; G06V 10/764; G06V 10/82; H04N 23/73

(57) ABSTRACT

A method, in particular a computer-implemented method, for recognizing a roadway coating on a roadway by means of a vehicle camera system of a vehicle is disclosed. The method includes providing a first image of the vehicle surroundings acquired with the vehicle camera system with a first exposure time; providing a second image of the vehicle surroundings with a second exposure time which is longer than the first exposure time; and determining a statement about the presence of a roadway coating at least on the basis of the second image. A computer program is disclosed which is configured to carry out the method, and to a computer-readable storage medium on which the computer program is stored.

### CROSS-REFERENCE TO RELATED APPLICATIONS

The present application is a National Stage Application under 35 U.S.C. § 371 of International Patent Application No. PCT/DE2023/200203 filed on Sep. 26, 2023,and claims priority from German Patent Application No. 10 2022 211 241.5 filed on Oct. 24, 2022, in the German Patent and Trademark Office, the disclosures of which are herein incorporated by reference in their entireties.

### TECHNICAL FIELD

The present invention relates to a method, in particular a computer-implemented method, for recognizing a roadway coating on a roadway, to a computer program for carrying out the method according to the invention, and to a computer-readable storage medium.

### BACKGROUND

Advanced driver assistance systems (ADAS) serve to support the driver of a vehicle. On the one hand, corresponding ADAS functions can be used to support the driver, while control of the driving of the vehicle remains with the driver. However, on the other hand, completely automated driving can also be realized with the aid of higher degrees of automation.

In the case of camera-based ADAS systems, the surroundings of the vehicle are captured by means of a camera system including at least one camera. In this connection, mono cameras, in particular front cameras, stereo cameras, or so-called surround-view camera systems, by means of which the entire environment of the vehicle can be captured, are known on the one hand.

When driving a vehicle, irrespective of whether the vehicle is being controlled manually or automatically, the roadway condition and therefore the friction coefficient between the tires and the roadway, which is available in each case, must constantly be taken into account and the respective driving style must be adapted to the prevailing conditions. In particular, the friction coefficient has a decisive influence on the reaction characteristics of vehicles such as, for example, during a braking process.

Thus, a roadway recognition system having a temperature sensor, an ultrasonic sensor and a camera has become known from DE102004018088A1. Measurement data captured by the existing sensors are compared with reference data and, on the basis of the comparison, the condition of the roadway surface can be determined by classifying the roadway surface (e.g., concrete, asphalt, dirt, grass, sand or gravel) and its condition (e.g., dry, icy, covered with snow, wet).

A method for establishing the road condition, in which road condition data from a weather map and/or road map are utilized for establishing the road condition and are subjected to a redigitization, is disclosed in DE102014214243A1.

WO2012/110030A2 describes a possible way of estimating the friction coefficient by means of a 3D camera. A height profile of the road surface is created from image data of the camera and the local friction coefficient to be expected is estimated. A classification of the roadway surface can be carried out in the individual case on the basis of special determined height profiles.

According to WO2013/117186A1, height profiles of the roadway surface which extend transversely to the direction of travel of the vehicle are determined on the basis of image data of a 3D camera along a multiplicity of lines, and the condition of the roadway surface is recognized on the basis of these profiles. Optionally, 2D image data of a mono camera can additionally be evaluated, e.g., by means of a texture or pattern analysis, and taken into account when recognizing the condition of the roadway surface.

It is proposed in EP3069296A1 that image data obtained by means of a camera system be evaluated with image processing and that indications of the presence of a roadway coating be specifically determined. The determined indications are then utilized during the establishment of a roadway coating and, if necessary, capturing of the roadway condition. Indications of the presence of a roadway coating are, for example, the effects of precipitation in the image data, on the roadway or on the vehicles or vehicle windshields, or the effects of a roadway coating when it is driven over by at least one tire of the vehicle.

### SUMMARY

An object of the present disclosure is to improve the detection possibilities with respect to the presence of a roadway coating.

This improvement is addressed by the method according to claim 1, the computer program according to claim 14, and the computer-readable storage medium according to claim 15.

With respect to the method, the improvement is addressed by a method, in particular a computer-implemented method, for recognizing a roadway coating on a roadway by means of a vehicle camera system of a vehicle, including the following method steps:
providing a first image of the vehicle surroundings acquired with the vehicle camera system, with a first exposure time,
providing a second image of the vehicle surroundings, with a second exposure time which is longer than the first exposure time, and
determining a statement about the presence of a roadway coating at least on the basis of the second image.

The first image is preferably an image acquired during the continuous operation of the vehicle camera system. Typically, the exposure time for vehicle camera systems is controlled automatically and is selected in each case in a suitable manner as a function of the lighting conditions. That is to say that the first image is an image with a substantially optimal exposure time. A longer exposure time, in particular compared to the optimal exposure time, as selected for the second image, leads to an increased motion blur which is usually to be avoided for downstream image evaluation. However, such an image with a longer exposure time can be advantageously used to recognize a roadway coating when traveling over it.

The vehicle camera system includes one or more cameras. For example, it can also be a so-called surround-view camera system. At least one camera can have a fisheye lens.

The camera system is preferably fastened to the vehicle in such a way that images of the surroundings of at least one wheel of the vehicle can be acquired by means of at least one camera of the vehicle camera system. Consequently, the first and/or second image is/are preferably an image which at least partially shows a wheel of the vehicle and the surroundings of the wheel, that is to say a region close to the wheel.

When driving on the roadway, any existing roadway coating is displaced by the tires, in particular forwards and sidewards. The displaced roadway coating is also visually captured by at least one camera of the vehicle camera system. The displaced roadway coating leads to a motion blur in the scattering direction due to a relative movement with respect to the moving vehicle and due to the longer exposure time for the second image. This is in turn exploited in order to recognize the presence of roadway coating.

According to an embodiment, the roadway coating is water, snow, ice, leaves or particles, in particular sand or dust. However, the roadway coating can also, in the most general sense, be any media/objects which lie flat (blanket, carpet) on the roadway coating (asphalt, tar, concrete, etc.). The phenomenon of lying flat on the roadway surface can be referred to as a blanket or carpet of the medium or of the objects. The roadway does not have to be completely covered with the roadway coating. That is to say that various types of roadway coating are conceivable, all of which fall within the scope of the present disclosure. For example, the statement about the presence of a roadway coating can accordingly also be a statement about the type of roadway coating.

In an embodiment of the method, a statement about a friction coefficient and/or a friction coefficient class for the vehicle which is located on the roadway is determined, in particular on the basis of the statement about the presence of the roadway coating, preferably on the basis of a type of roadway coating. The statement about the friction coefficient can be established in different ways. The statement about the friction coefficient is preferably determined on the basis of the statement about the presence of a roadway coating. A driving strategy can in turn be advantageously derived from the friction coefficient, for example with respect to reaction properties, for example in emergency situations.

For example, a method for determining the roadway friction coefficient according to friction coefficient classes on the basis of a determined friction coefficient parameter is described in DE102009041566B4.

In an advantageous embodiment of the method according to the present disclosure, the roadway coating is water, wherein a water depth is determined. The water depth is directly related to the amount of water and can, for example, also be established on the basis of a determined amount of water, which is in particular displaced by one or more tires per unit of time. In addition to knowledge of the friction coefficient, knowledge of a water depth is also crucial for a driving strategy which is appropriate to the situation.

It is advantageous if a statement about a risk of aquaplaning is determined on the basis of the water depth, a speed of the vehicle and/or a slip behavior of at least one tire of the vehicle. Consequently, the method according to the present disclosure makes it possible to make a statement about an aquaplaning risk.

A distinction between a wet roadway, precipitation and an aquaplaning risk can advantageously be made on the basis of a size and/or intensity of water droplets detected in the first and/or second image, a detected amount of splash water and/or on the basis of detected water clusters.

As the driving speed increases when there is an aquaplaning risk, i.e., if there is a lot of water on the road, a water cloud or water spray frequently forms. This can be advantageously utilized to make the statement about an aquaplaning risk, in particular for recognizing an acute aquaplaning risk. For example, detected water drops, a detected amount of splash water, the presence of water clusters or a water cloud or water spray can be divided into predefinable classes. Moreover, when making an assessment with respect to an aquaplaning risk, a speed of the vehicle on the roadway can and/or should also be taken into account.

According to an embodiment of the method according to the present disclosure, the second exposure time is selected as a function of the first exposure time established by an exposure control/regulation device. That is to say that the vehicle has an exposure control/regulation device, by means of which an exposure time for the vehicle camera system is established during continuous operation. The exposure time is preferably continuously regulated or controlled and adapted to the respective lighting conditions in the surroundings of the vehicle. The second, longer exposure time is then selected starting from a current value for the first exposure time adjusted by means of the exposure control/regulation device.

It is advantageous if the second exposure time is selected as a function of a speed of the vehicle. In this way, the displaced roadway coating, in particular a sideways movement in the scattering direction, can be made optimally visible.

It is further advantageous if the second exposure time is selected as a function of a brightness of the surroundings of the vehicle. That is to say that the second exposure time is selected as a function of current lighting conditions.

In an embodiment of the method according to the present disclosure, starting from the first exposure time, the second exposure time is gradually increased, in particular at predefinable intervals or in predefinable stages, or by means of a predefinable factor. The stages or intervals are preferably selected in a such way that a height of the stage or a length of the interval varies, for example grows exponentially. However, the second exposure time can also be determined on the basis of a weighing method. It is advantageous if, starting from the first exposure time, the second exposure time is increased until a predefinable criterion is met. In this connection, a wide variety of criteria can be utilized such as, for example, the visibility of certain elements in an image acquired by means of the vehicle camera system or similar.

According to a particularly preferred embodiment of the method according to the present disclosure, the statement about the presence of a roadway coating and/or in particular a type of roadway coating is determined by means of a method from the field of machine learning.

In this respect, it is advantageous if the statement about the presence of a roadway coating and/or in particular a type of roadway coating is determined using at least one neural network, in particular a trained neural network, wherein the neural network is configured to determine and to output the presence of a roadway coating and/or in particular a type of roadway coating at least on the basis of the second image.

The statement about the presence of a roadway coating can be the most diverse types of statements. On the one hand, a statement can be made about the presence of any roadway coating on the roadway. However, it can also be determined either where the roadway coating is located and how much roadway coating is present. Alternatively or additionally, it can be determined which type of roadway coating, i.e., what kind of roadway coating, it is in each case.

The neural network is preferably a convolutional neural network (CNN), a recurrent neural network (RNN), or a so-called region proposal network (RPN). In the event that a trained neural network is used for making a statement about the presence of roadway coating and/or in particular a type of roadway coating, image data from images of various scenarios acquired by means of vehicle camera systems, which are labeled manually, for example, can be used to train the network. However, it is also possible to generate suitable training data at least partially synthetically.

Moreover, a suitable reference sensor can also be used to train the neural network, which establishes a statement about the presence of a roadway coating and/or in particular a type of roadway coating very reliably and precisely, and by means of which training target values can be predefined.

An alternative embodiment involves the statement about the presence of a roadway coating and/or in particular a type of roadway coating being determined using at least one decision tree, in particular on the basis of a random forest. That is to say that it is equally possible to determine the presence of a roadway coating and/or in particular a type of roadway coating on a roadway on the basis of an evolutionary method.

The method according to the present disclosure according to any one of the embodiments described here is advantageously used when recognizing the presence of a roadway coating at night or in the case of little or no lighting. The method according to the present disclosure can accordingly be particularly advantageously used in night situations with low or no lighting, for example during cross-country driving without scattered light from outside. The present disclosure is based on the finding that when the method according to the present disclosure is used at night or in the case of low or no lighting, residual light from the vehicle headlights in combination with the second exposure time is sufficient to make a statement about the presence of roadway coating.

The object of the present disclosure is further addressed by a system for data processing, including means for carrying out the method according to the present disclosure according to any one of the described embodiments.

In addition, the object of the present disclosure is addressed by a computer program including commands which, when the program is run by a computer, prompt the computer to carry out the method according to the present disclosure according to any one of the described embodiments, as well as by a computer-readable storage medium on which the computer program according to the present disclosure is stored.

### BRIEF DESCRIPTION OF THE DRAWINGS

The invention as well as its advantageous embodiments are explained in more detail below with reference to the following figures, wherein:

FIG. 1 shows a flow chart for illustrating the method according to the present disclosure;

FIG. 2 shows a flow chart for an embodiment of the method according to the present disclosure using machine learning methods; and

FIG. 3 shows images of a region of a vehicle close to the wheel in the presence of different roadway coatings.

### DETAILED DESCRIPTION

The method according to the present disclosure is illustrated in FIG. 1. In a first step, a first image I₁ acquired by a vehicle camera system is provided, with a first exposure time b₁. In addition, a second image I₂ is provided, with a second exposure time b₂. Optionally, the second exposure time b₂ can be selected as a function of the first exposure time b₁. This variant is accordingly depicted in dashed lines in FIG. 1. The second exposure time b₂ is then any function of the first exposure time b₁. In addition, when selecting the second exposure time, for example, a speed v of the vehicle and/or a brightness of the vehicle's surroundings, that is to say the prevailing lighting conditions in each case, can be taken into account.

According to the present disclosure, the second exposure time b₂ is longer than the first exposure time b₁. In this way, a statement about the presence of a roadway coating F can be determined on the basis of the second image I₂. Moreover, statements about a friction coefficient of the vehicle on the roadway or, in the case that the roadway coating is water, statements about a water depth and/or an aquaplaning risk can also be determined.

Likewise optionally, and therefore depicted in dashed lines, the first exposure time can be established, in particular regulated or controlled, by an exposure control/regulation device 2. In this case, the first exposure time b₁ is continuously automatically selected in a suitable manner and is optimized in particular with respect to an image evaluation downstream of the acquisition of an image I.

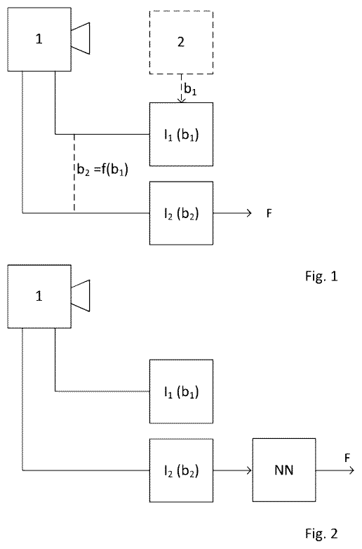

An advantageous embodiment of the method according to the present disclosure is illustrated in FIG. 2, in which machine learning methods are utilized to determine the statement about the presence of the roadway coating F. For the embodiment shown, the second image I₂ is made available to a trained neural network NN as an input. The neural network NN is configured to determine and to output the presence of a roadway coating F at least on the basis of the second image I₂.

However, according to the present disclosure, other machine learning methods can also be deployed such as, for example, decision trees.

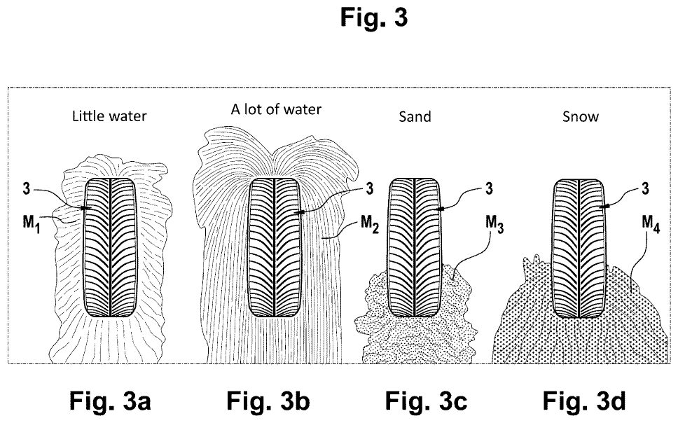

In the case that a roadway coating F is present, the roadway coating is displaced, in particular forwards and to the side, by the tires when the vehicle is driving on the roadway. The displaced roadway coating F causes a motion blur in the scattering direction due to a relative movement with respect to the moving vehicle and due to the longer exposure time b₂ for the second image I₂, which motion blur is exploited to recognize the presence of roadway coating F. Thus, due to the movement of the vehicle on the roadway and due to the relative movement of the displaced roadway coating F and reflections of scattered light on the displaced roadway coating F, characteristic patterns arise in the second image I₂ with the longer exposure time b₂ relative to the direction of movement of the vehicle. For example, a distinction can be made between different color hues, shapes, dimensions and orientations relative to a predefinable axis of the patterns. For example, such image blurs which are pronounced diagonally forwards or sideways within the image I₂ are caused exclusively by displaced roadway coating F. That is to say that it is possible to derive a statement about the presence of a roadway coating F on the basis of the resulting characteristic patterns. This is explained in more detail on the basis of FIG. 3.

Four different camera images of a region of a vehicle close to the wheel, that is to say of a tire 3 and its immediate surroundings, are shown for four different roadway coatings F by way of example in FIG. 3. Corresponding images can, for example, be acquired by means of a surround-view camera. However, other types of camera systems are also conceivable and possible within the framework of the present disclosure.

FIG. 3a relates to the case of a slightly wet road. The tire 3 is surrounded by a characteristic first pattern M₁, which becomes visible due to the longer exposure time b₂ for the second image I₂. By contrast, a comparable image for the case of a significantly wetter roadway is depicted in FIG. 3b. The characteristic pattern M₂ resulting in this case differs significantly from the first characteristic pattern M₁ from FIG. 3a. It is made clear on the basis of FIG. 3a and FIG. 3b that a distinction can be safely made between different degrees of wetness of a roadway. In the case of a higher degree of wetness (FIG. 3b), both the amount and the intensity of the liquid displaced by the tires is significantly greater.

To determine an aquaplaning risk, for example, various classes can be formed for different amounts of water and intensities of the water displacement occurring in each case due to the tires. In this way, a distinction can be made between various risk classes for the occurrence of aquaplaning, for example by additionally taking into account a vehicle speed. However, other types of evaluation of the characteristic patterns M in the second image I₂ in each case with the longer exposure time b₂ are also conceivable for determining the water depth and/or an aquaplaning risk and fall within the scope of the present disclosure.

Finally, a characteristic pattern M₃ when sand is present on the roadway is depicted in FIG. 3c, and a characteristic pattern M₄ when snow is present on the roadway is depicted in FIG. 3d. That is to say that the present disclosure is not limited to recognizing any roadway coating on the roadway. Rather, the type of roadway coating present in each case can also be safely determined. It is an advantage of the present disclosure that the presence of a roadway coating, that is to say, a roadway condition, or even an aquaplaning risk can be determined reliably and independently of external lighting conditions in the surroundings of the vehicle, that is to say, in particular including at night or in cases of little or no lighting in the surroundings of the vehicle, with conventional, including in particular with inexpensive, cameras.

1. A computer-implemented method, for recognizing a roadway coating on a roadway by a vehicle camera system of a vehicle, the method comprising:
providing a first image of the vehicle surroundings acquired with the vehicle camera system, with a first exposure time,
providing a second image of the vehicle surroundings with a second exposure time which is longer than the first exposure time, and
determining a statement about the presence of a roadway coating at least on the basis of the second image.

2. The method according to claim 1, wherein the roadway coating is at least one of water, snow, ice, leaves, particles comprising sand or dust.

3. The method according to claim 1, further comprising determining a statement about at least one of a friction coefficient or a friction coefficient class for the vehicle which is located on the roadway, on the basis of at least one of the statement about the presence of the roadway coating or a type of roadway coating.

4. The method according to claim 1, wherein the roadway coating is water, and the method further comprises determining a depth of the water forming the roadway coating.

5. The method according to claim 4, further comprising determining a statement about a risk of aquaplaning on the basis of at least one of the water depth, a speed of the vehicle or a slip behavior of at least one tire of the vehicle.

6. The method according to claim 1, further comprising selecting the second exposure time as a function of the first exposure time established by an exposure control or/regulation device.

7. The method according to claim 1, further comprising selecting the second exposure time as a function of a speed of the vehicle.

8. The method according to claim 1, further comprising selecting the second exposure time as a function of a brightness of the vehicle surroundings.

9. The method according to claim 1, starting from the first exposure time, the second exposure time is gradually increased, at predefinable intervals, in predefinable stages, or a predefinable factor.

10. The method according to claim 1, further comprising determining a type of roadway coating, wherein at least one of determining the statement about the presence of a roadway coating or determining a type of roadway coating uses, machine learning.

11. The method according to claim 10, wherein the at least one of determining the statement about the presence of a roadway coating or determining the type of roadway coating uses at least one trained neural network wherein the trained neural network is configured to determine and to output at least one of the presence of the roadway coating a type of the roadway coating at least on the basis of the second image.

12. The method according to claim 10, wherein the at least one of determining the statement about the presence of a roadway coating or determining the type of roadway coating is determined using at least one decision tree on the basis of a random forest.

13. Use of the method according to claim 1 for recognizing a roadway coating in the case of little or no lighting.

14. A computer program stored in a non-transitory computer-readable storage medium and comprising commands which, when the computer program is executed by a computer, prompt the computer to carry out the method according to claim 1.

15. (canceled)
